(19) United States
(12) Patent Application Publication
(10) Pub. No.: US 2003/0002138 A1
(43) Pub. Date: Jan. 2, 2003

(54) Gain stabilized raman effect optical amplifiers for coarse and dense wavelength multiplexers

(75) Inventors: Casimer Maurice DeCusatis, Poughkeepsie, NY (US); Lawrence Jacobowitz, Wappingers Falls, NY (US)

Correspondence Address: Steven Fischman, Esq., Scully, Scott, Murphy & Presser, 400 Garden City Plaza, Garden City, NY, 11530, US

(73) Assignee: INTERNATIONAL BUSINESS MACHINES CORPORATION, ARMONK, NY (US)

(21) Appl. No.: 09/893,125

(22) Filed: Jun. 27, 2001

(51) Int. Cl. H01S 3/00

(52) U.S. Cl. 359/334

(57) ABSTRACT

A system and method for controlling alignment of a laser center wavelength and Raman filter passband center wavelengths in a Raman effect optical amplifier for purposes of providing increased gain response. The system and method exploits a wavelength-locked loop servo-control circuit and methodology that enables real time mutual alignment of a laser pump signal having a peaked spectrum function including a center wavelength and the center wavelength of a passband filter having a peaked passband function provided in the Raman amplifier.

### BACKGROUND OF THE INVENTION

1. Field of the Invention

The present invention relates generally to optical devices such as lasers, and fiber optic data transmission systems employing the same, and particularly to a novel wavelength-locked loop servo-control circuit for optimizing performance of Raman effect optical amplifiers.

2. Description of the Prior Art

Wavelength Division Multiplexing (WDM) and Dense Wavelength Division Multiplexing (DWDM) are light-wave application technologies that enable multiple wavelengths (colors of light) to be paralleled into the same optical fiber with each wavelength potentially assigned its own data diagnostics. Currently, WDM and DWDM products combine many different data links over a single pair of optical fibers by re-modulating the data onto a set of lasers, which are tuned to a very specific wavelength (within 0.8 nm tolerance, following industry standards). On current products, up to 32 wavelengths of light can be combined over a single fiber link with more wavelengths contemplated for future applications. The wavelengths are combined by passing light through a series of thin film interference filters, which consist of multi-layer coatings on a glass substrate, pigtailed with optical fibers. The filters combine multiple wavelengths into a single fiber path, and also separate them again at the far end of the multiplexed link. Filters may also be used at intemediate points to add or drop wavelength channels from the optical network.

Optical amplifiers are used to extend the distance of transmitted signals in fiber optic networks. This enables optical signals to be amplified without incurring the additional latency (and computer performance impact) of an optical-to-optical conversion. Optical amplifiers additionally offer lower timing jitter in some cases, and improved performance on long links.

There are many kinds of optical amplifiers used in dense wavelength division multiplexing (WDM) networks. One example is the erbium doped optical amplifier that is used to extend link distances to over 100 km. However, erbium doped fiber amplifiers (EDFAs) are somewhat expensive to implement, and can only amplify light in the wavelength range near 1550 nm; thus, they are only used in WDM networks, and not to amplify links which operate at lower wavelengths 1300 nm such as ESCON (Enterprise Systems Connection), sysplex timer, or Gigabit Ethernet networks. A less expensive optical amplifier is desirable for these applications. Furthermore, an amplifier which operates at both 1300 nm and 1550 nm would be useful in channel extension of coarse WDM systems, which use only these two widely spaced wavelengths or a few additional wavelengths between these extremes. One option for implementing the emerging 10 Gbit/s Ethernet and Fibre Channel protocols is to use coarse WDM transceivers, because it may be easier and more cost effective to implement a coarse multiplex of 4 channels running at 3.3 Gbit/s than a serial link at 10 Gbit/s. Since the distance of coarse WDM links is limited to a few hundred meters, amplification of the optical signal is desirable.

One inexpensive type of optical amplifier is the well-known Raman effect amplifier, which exploits the Raman scattering effect when light of sufficient energy impinges upon a material. Specifically, the Raman spectrum of scattered light are at wavelengths shifted from the frequency of the impinging light source signal and represent a vibrational characteristic of the physical medium. In the context of optical amplification, Raman amplification is based on stimulated Raman scattering (SRS), which is a nonlinear effect in fiber-optical transmission that results in signal amplification when optical pump waves with the correct wavelength and power are launched into a length of fiber. When a sufficiently large pump wave is co-launched at a higher frequency (smaller wavelength) than the signal to be amplified, the Raman gain depends strongly on the pump power and the frequency offset between pump and signal. Amplification occurs when the pump photon gives up its energy to create a new photon at the signal wavelength, plus some residual energy.

More specifically, when the optical power in the optical fiber core exceeds some threshold value, light is scattered from small imperfections in the fiber core or from molecular vibrations induced by the high intensity electromagnetic fields in the fiber core. The scattering process involves the generation of phonons (acoustic pulses) so the light may also be frequency (wavelength) shifted. When the scattered light is frequency shifted outside a certain acoustic range, the process is called SRS. The threshold where SRS occurs depends on a number of factors, including the material properties of the fiber. Typically a pump of about half a watt or more is required. In a Raman amplifier, a high power (over the SRS threshold) pump wavelength down the fiber, and the SRS effect generates a new signal (called a Stokes wave) that travels in the same direction as the pump but is down-shifted by 13.2 THz (this is a property of the SRS effect). Thus, if there is a signal in the fiber carrying data to be amplified, a pump laser may be sent in which is 13.2 THz higher in frequency (shorter in wavelength) than the signal, and the SRS scattered light would come out at the same wavelength as the data, thereby amplifying it. Although the pump and signal do not have to be spaced exactly 13.2 THz to achieve gain, the Raman effect gets much less efficient if the difference is much different from 13.2 THz. A useful range if from about a 10 nm −20 nm wavelength difference (around 400 GHz).

As shown in FIG. 1, the basic Raman amplifier receives an input optical signal 120 which may be passed through a circulator or optical isolator 130 to remove unwanted noise, and then through a coupler device 150, enters a section of singlemode optical fiber 170, e.g., about 1 km length of fiber, to carry the signal. Raman amplification is provided by a laser diode pump (LD pump) 110, similar to an Raman effect laser system, that generates a pump laser signal 160 to pump the amplifier at fairly high power (e.g., 100 mW or greater). The Raman amplification effect requires that the pump wavelength additionally be spaced about 13.2 THz, e.g., about 0.2 nm, (the Raman shift) higher than the wavelength of the input signal 120—with higher gains achievable when the spacing is closer to this value.

In common germanium-doped fibers, the Raman effect is fairly weak so it is desirable to pump as close as possible to this spacing. However, it is currently not possible to build lasers with arbitrarily high power output at a precise wavelength; instead, high power laser diodes are designed to run close to the Raman shift and their output is passed through a wavelength filter to remove undesirable components. Thus, the alignment between a laser's center wavelength and the Raman filter passband is critical to obtaining enough gain to build a practical Raman-effect amplifier device.

It would be highly desirable to provide a system and methodology that ensures wavelength alignment between the pump laser and Raman filter to produce optimal gain from a Raman effect optical amplifier.

### SUMMARY OF THE INVENTION

It is therefore an object of the present invention to provide a system and method for enabling mutual alignment of the center frequency of the pump laser power and the Raman filter for enabling precise laser pumping of the Raman amplifier at the optimum wavelength.

It is another object of the present invention to provide a servo-control feedback loop for a Raman effect optical amplifier implemented in a WDM system, that enables dynamic mutual alignment of the center frequency of the pump laser power and the Raman filter for enabling precise laser pumping of the Raman amplifier at the optimum wavelength.

It is still another object of the present invention to provide a servo/feedback loop, referred to as a “wavelength-locked loop,” that enables dynamic gain stabilization of a Raman effect amplifier implemented in multi-gigabit laser/optical systems, thereby enabling significantly larger link budgets and longer supported distances.

It is yet still another object of the present invention to provide a servo/feedback loop, referred to as a “wavelength-locked loop,” that enables dynamic gain control adjustment of a Raman effect amplifier implemented in multi-gigabit laser/optical systems such that lower cost lasers and filters may be used providing a significant cost reduction in the equipment utilized.

Thus, according to one aspect of the invention, there is provided an Raman effect Raman amplifier for amplifying optical signals comprising: an optical isolator device for receiving an input optical signal having an input frequency characteristic; a laser pump device for generating a laser pump signal having a peaked spectrum function including a center wavelength; a Raman filter element having a peaked passband function including a center wavelength implemented for receiving the laser pump signal and passing the laser pump signal at a pre-determined wavelength advantageous for amplifying the input signal according to a Raman effect; an optical fiber element for receiving the input optical signal and the laser pump signal and amplifying the input optical signal according to the Raman effect in response to receipt of a laser pump signal at the pre-determined wavelength; and, a wavelength-locked loop servo-control circuit for enabling real time mutual alignment of the laser pump signal center wavelength with the Raman filter having the peaked passband function at the pre-determined wavelength, wherein the laser pump signal is maximally transferred to the optical fiber element at the pre-determined wavelength thereby resulting in increased gain response of the Raman effect amplifier at the input frequency.

According to another aspect of the invention, the filter element may comprise a series connection of two or more Raman filter elements capable of for providing a composite peaked passband function including a center wavelength implemented for receiving and passing a laser pump signal at a pre-determined wavelength advantageous for amplifying the input signal according to a Raman effect. Furthermore, one or more Bragg grating elements may be provided to enable a conversion of a center wavelength of the laser pump signal to the pre-determined wavelength.

Advantageously, the Raman effect amplifier is an inline optical fiber amplifier, requiring at least 1 km of doped fiber in the signal path and providing increasing gain if longer fiber sections are used. Raman effect amps are better suited for longer communication link (tens to hundreds of km or more). Thus, the system and method of the present invention may be employed in optical networks such as WDM and DWDM systems.

### BRIEF DESCRIPTION OF THE DRAWINGS

Further features, aspects and advantages of the apparatus and methods of the present invention will become better understood with regard to the following description, appended claims, and the accompanying drawings where:

FIG. 1 is a block diagram illustrating the primary components of a Raman effect optical amplifier;

FIGS. 2(a) and 2(b) depict examples of underlying wavelength-locked loop system architectures;

FIG. 2(c) is a general block diagram depicting the underlying system architecture for tuning tunable frequency selective devices such as a bandpass filter according to the principles of the present invention;

FIGS. 3(a)-3(b) are signal waveform diagrams depicting the relationship between laser optical power as a function of wavelength for three instances of optic laser signals;

FIGS. 4(a)-4(c) are signal waveform diagrams depicting the laser diode drive voltage dither modulation (a sinusoid) for each of the three waveform diagrams of FIGS. 3(a)-3(c);

FIGS. 5(a)-5(c) are signal waveform diagrams depicting the resulting feedback error signal output of the PIN diode for each of the three waveform diagrams of FIGS. 3(a)-3(c);

FIGS. 6(a)-6(c) are signal waveform diagrams depicting the cross product signal resulting from the mixing of the amplified feedback error with the original dither sinusoid;

FIGS. 7(a)-7(c) are signal waveform diagrams depicting the rectified output laser bias voltage signals which are fed back to adjust the laser current and center frequency;

FIGS. 8 illustrates a Raman effect amplifier design employing the WLL principle for increasing gain response according to the principles of the invention;

FIGS. 9(a) illustrates an alternate embodiment of the Raman effect amplifier according to the invention.

FIG. 9(b) is a graphical depiction of the wavelength shift resulting from multi-stage filtering in the Raman amplifier according to the alternate embodiment of the invention.

FIG. 10 is a detailed block diagram illustrating conceptually the operation of the digital control circuit 145 of FIGS. 8 and 9(a).

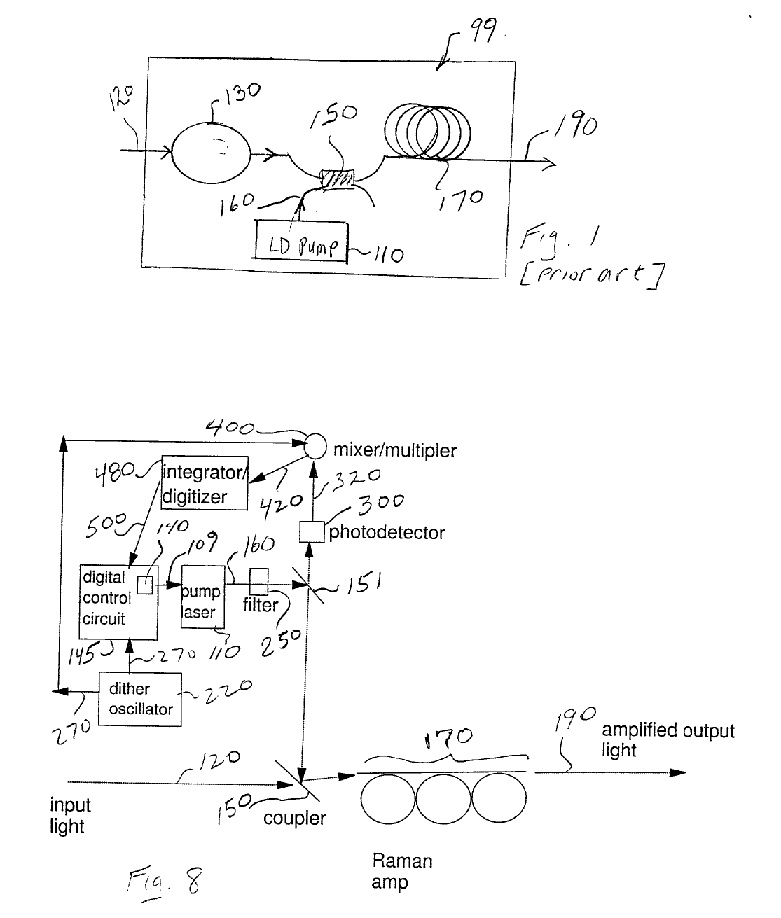

### DETAILED DESCRIPTION OF PREFERRED EMBODIMENTS

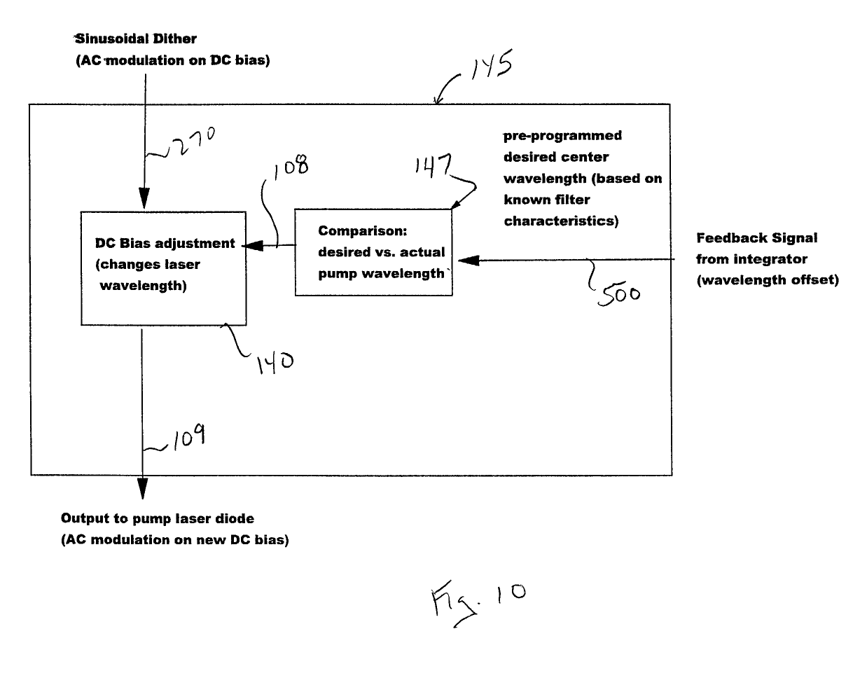

The present invention is directed to a gain-stabilized Raman effect optical amplifier implementing a novel servo-control loop for providing a stable, optical pump laser signal at a desired wavelength which can be used to increase the gain response. When integrated in a Raman amplifier, employed in WDM systems, as will be particularly described with respect to FIGS. 8-9(a), the novel servo-control loop may be used to dynamically align a laser's center wavelength and a Raman filter passband to achieve gain sufficient for practical application of a Raman-effect amplifier device.

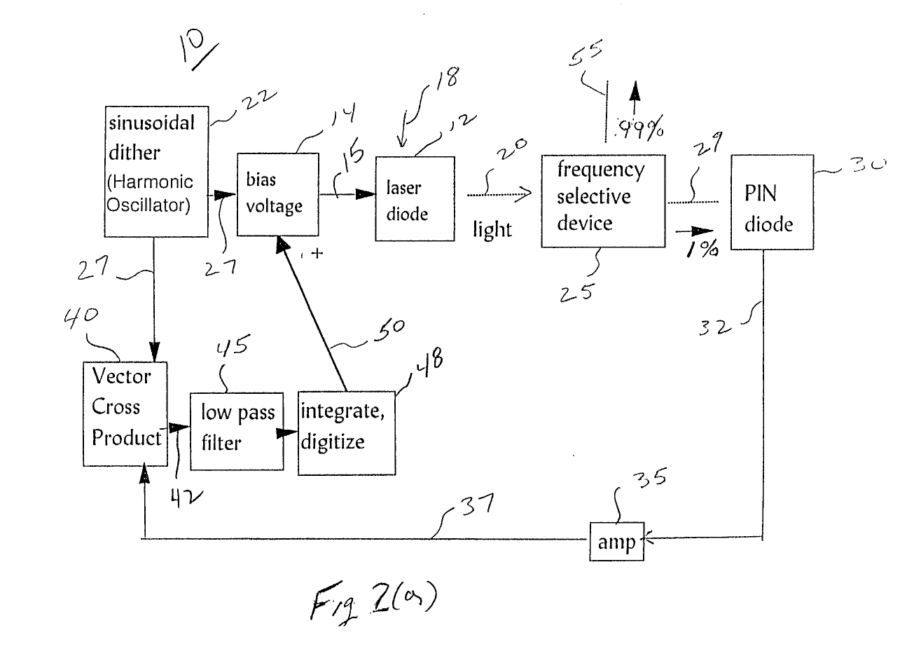

As shown in FIG. 2(a), the novel servo-control system implements a principle referred to herein as the “wavelength-locked loop” or “lambda-locked loop” (since the symbol lambda is commonly used to denote wavelength). The basic operating principle of the wavelength-locked loop (WLL) is described in greater detail in commonly-owned, co-pending U.S. patent application Ser. No. 09/865,256, entitled APPARATUS AND METHOD FOR WAVELENGTH-LOCKED LOOPS FOR SYSTEMS AND APPLICATIONS EMPLOYING ELECTROMAGNETIC SIGNALS, the whole contents and disclosure of which is incorporated by reference as if fully set forth herein.

Particularly, as described in commonly-owned, co-pending U.S. patent application Ser. No. 09/865,256, and with reference to FIG. 2(a), the wavelength-locked loop principle implements a dither modulation to continuously adjust an electromagnetic signal source characterized as having a peaked frequency spectrum or peaked center wavelength, e.g., a laser light source, so as to track the center of a frequency selective device, e.g. a filter passband. In this manner, optimal power of the signal is transmitted and optimal use is made of the system transmission bandwidth. The principle may be exploited for tuning any light source having a peaked frequency spectrum, and additionally, may be used to tune or adjust transmission properties of frequency selective devices such as tunable filters.

For purposes of description, the basic operating principle of the WLL is shown in FIG. 2(a) which depicts an example optic system 10 including a light source such as laser diode 12 driven with both a bias voltage 15 from a voltage bias circuit 14, and modulated data 18 from a data source (not shown). The laser diode generates an optical (laser light) signal 20 that is received by a bandpass filter 25 or, any frequency selective device including but not limited to: thin film optical interference filters, acousto-optic filters, electro-optic filters, diffraction gratings, prisms, fiber Bragg gratings, integrated optics interferometers, electroabsorption filters, and liquid crystals. The laser diode itself may comprise a standard Fabry Perot or any other type (e.g., Vertical Cavity Surface Emitting (VCSEL)), light emitting diodes, or, may comprise a Distributed Feedback semiconductor laser diode (DFB) such as commonly used for wavelength multiplexing. Preferably, the laser diode emits light in the range of 850 nm to 1550 nm wavelength range. As mentioned, the bandpass filter may comprise a thin film interference filter comprising multiple layers of alternating refractive indices on a transparent substrate, e.g., glass. As further shown in FIG. 2(a), according to the invention, there is an added sinusoidal dither modulation circuit or oscillator 22 for generating a sinusoidal dither modulation signal 27 that modulates the laser bias voltage. The sinusoidal dither signal may be electronically produced, e.g., by varying the current for a laser, or mechanically, by varying the micro-electromechanical system's (MEMS) mirror to vary the wavelength. The dither modulation frequency is on the order of a few kilohertz (kHz) but may range to the Megahertz range. Preferably, the dither modulation frequency is much less than the data rate which is typically on the order of 1-10 GHz. Modulation of the laser diode bias current 15 in this manner causes a corresponding dither in the laser center wavelength. Modulated data is then imposed on the laser, and the optical output passes through the bandpass filter 25. Preferably, the filter 25 is designed to tap off a small amount of light 29, for example, which is incident upon a photo detector receiver device, e.g., P-I-N diode 30, and converted into an electrical feedback signal 32. The amount of light that may be tapped off may range anywhere between one percent (1%) to five percent (5%) of the optical output signal, for example, however, skilled artisans will appreciate any amount of laser light above the noise level that retains the integrity of the output signal including the dither modulation characteristic, may be tapped off. The remaining laser light passes on through the filter 25 to the optical network (not shown). As the PIN diode output 32 is a relatively weak electric signal, the resultant feedback signal is amplified by amplifier device 35 to boost the signal strength. The amplified electric feedback signal 37 is input to a multiplier device 40 where it is combined with the original dither modulation signal 35. The cross product signal 42 that results from the multiplication of the amplified PIN diode output (feedback signal) 37 and the dither signal 35 includes terms at the sum and difference of the dither frequencies. The result is thus input to a low pass filter device 45 where it is low pass filtered and then averaged by integrator circuit 48 to produce an error signal 50 which is positive or negative depending on whether the laser center wavelength is respectively less than or greater than the center 15 point of the bandpass filter. The error signal 50 is input to the laser bias voltage device where it may be added (e.g., by an adder device, not shown) in order to correct the laser bias current 15 in the appropriate direction. In this manner, the bias current (and laser wavelength) will increase or decrease until it exactly matches the center of the filter passband. Alternately, the error signal 50 may be first converted to a digital form, prior to input to the bias voltage device.

According to one aspect of the invention, the WLL will automatically maintain tracking of the laser center wavelength to the peak of the optical filter. However, in some cases, it may not be desirable to enable laser alignment to the filter peak, e.g., in an optical attenuator. Thus, as shown in FIG. 2(b) which is a system 10′ corresponding to the system 10 of FIG. 2(a), there is provided an optional external tuning circuit, herein referred to as a wavelength shifter device 51, that receives the error signal and varies or offsets it so that the laser center wavelength may be shifted or offset in a predetermined manner according to a particular network application. That is, the wavelength shifter 51 allows some external input, e.g., a manual control element such as a knob, to introduce an arbitrary, fixed offset between the laser center wavelength and the filter peak.

It should be understood that, as described in commonly-owned, co-pending U.S. patent application Ser. No. 09/865,256, the WLL servo-control system may be implemented for tuning tunable frequency selective devices such as a bandpass filter for a variety of optical network applications, including optical amplifier circuits, such as provided in the present invention. Thus, in the embodiment depicted in FIG. 2(c), the system 10″ comprises similar elements as system 10 (of FIG. 2(a)) including a bias voltage generator device 14 for applying a bias signal 15 to the laser diode 12 for generating an optical signal 20 having a peaked spectrum function. This signal 20 is input to a tunable frequency selective device 25, e.g., a tunable bandpass filter. As shown in FIG. 2(c), however, the sinusoidal dither/driver device 22 is implemented for modulating the peak center frequency of filter pass band with a small dither signal 27. A small amount of light 29 is tapped off the output of the filter 25 for input to the photodetector device, e.g., PIN diode 30, where the optical signal is converted to electrical signal 32, amplified by amplifier device 35, and input to the mixer device 40 which additionally receives the dither signal 27. The mixer device generates the vector cross product 42 of the amplified feedback signal 37 with the dither signal 27 and that result is low-pass filtered, and smoothed (e.g., integrated) by integrator device 48 to provide error signal 50, in the manner as will be discussed herein with reference to FIGS. 3-7. This error signal 50 may be a bi-polar signal and may be used to dynamically adjust the peak center frequency of the filter passband until it matches the center frequency of the laser signal input 20.

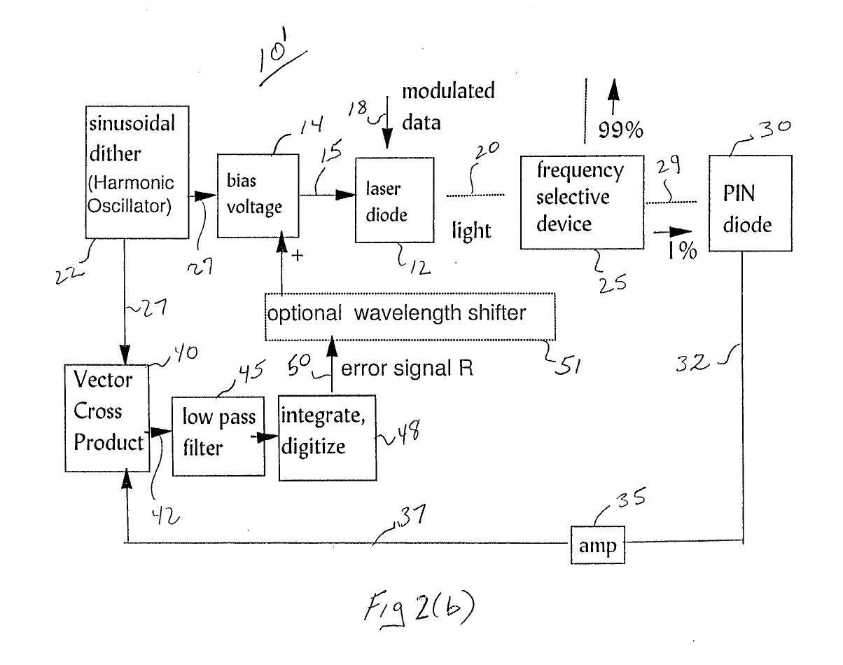

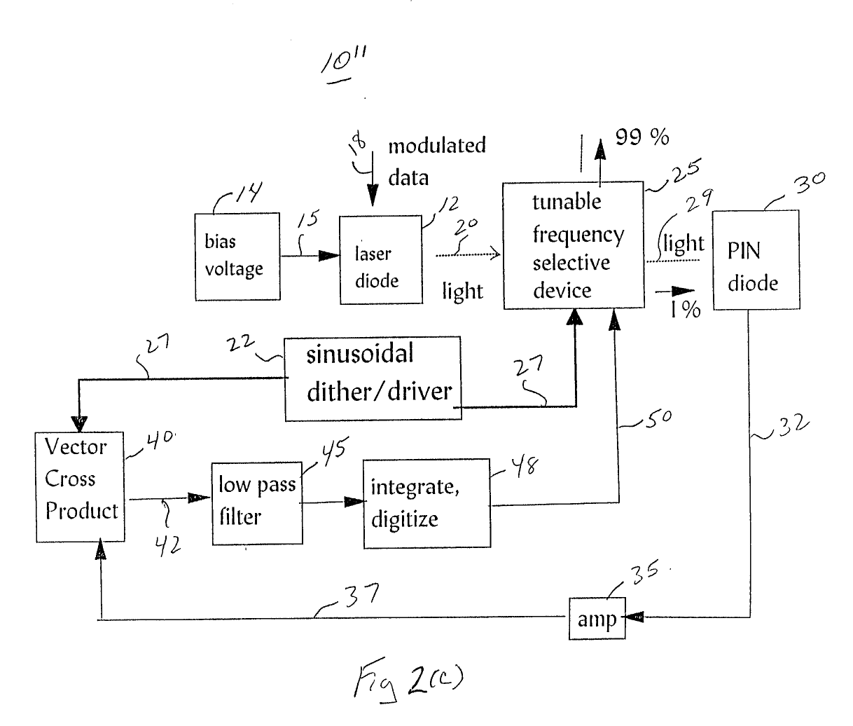

The operating principle of the WLL is further illustrated in the timing and signal diagrams of FIGS. 3-7. FIGS. 3(a)- 3(c) particularly depicts the relationship between laser optical power as a function of wavelength for three instances of optic laser signals: a first instance (FIG. 3(a)) where the laser signal frequency center point 21 is less than the bandpass function centerpoint as indicated by the filter bandpass function 60 having centerpoint 62 as shown superimposed in the figures; a second instance (FIG. 3(b)) where the laser frequency center point 21 is aligned with the bandpass function centerpoint 62; and, a third instance (FIG. 3(c)) where the laser frequency center point 21 is greater than the bandpass function centerpoint 62. In each instance, as depicted in corresponding FIGS. 4(a)-4(c), the laser diode drive voltage signal 15 is shown dithered (a sinusoid) resulting in the laser wavelength dithering in the same manner. The dithered laser diode spectra passes through the filter, and is converted to electrical form by the PIN diode 30. In each instance of the laser signals depicted in FIGS. 3(a) and 3(c) having frequency centerpoints respectively less than and greater than the band pass filter centerpoint, it is the case that the dither harmonic spectra does not pass through the frequency peak or centerpoint of the bandpass filter. Consequently, the resulting output of the PIN diode is an electric sinusoidal signal of the same frequency as the dither frequency such as depicted in corresponding FIGS. 5(a) and 5(c). It is noted that for the laser signals at frequencies below the peak (FIG. 3(a)) the feedback error signal 32 corresponds in frequency and phase to the dither signal (FIG. 5(a)), however for the laser signals at frequencies above the peak (FIG. 3(c)) the feedback error signal 32 corresponds in frequency but is 180° opposite phase of the dither signal (FIG. 5(c)). Due to the bipolar nature of the feedback signal (error signal) for cases when the laser signal centerpoint is misaligned with the bandpass filter centerpoint, it is thus known in what direction to drive the laser diode (magnitude and direction), which phenomena may be exploited in many different applications. For the laser signal depicted in FIG. 3(b) having the laser frequency center point aligned with the bandpass function centerpoint, the dither harmonic spectra is aligned with and passes through the frequency peak (maximum) of the bandpass filter twice. That is, during one cycle (a complete round trip of the sinusoid dither signal), the dither signal passes though the centerpoint twice. This results in a frequency doubling of the dither frequency of the feedback signal 32, i.e., a unique frequency doubling signature, as depicted as PIN diode output 32′ in FIG. 5(b) showing an feedback error signal at twice the frequency of the dither frequency.

Thus, in each instance, as depicted in corresponding FIG. 5(b), the resulting feedback signal exhibits frequency doubling if the laser center wavelength is aligned with the filter center wavelength; otherwise it generates a signal with the same dither frequency, which is either in phase (FIG. 5(a)) or out of phase (FIG. 5(c)) with the original dither modulation. It should be understood that, for the case where there the laser center frequency is misaligned with the bandpass filter peak and yet there is exhibited partial overlap of the dither spectra through the bandpass filter peak (i.e., the centerpoint peak is traversed twice in a dither cycle), the PIN diode will detect partial frequency doubling laser at opposite phases depending upon whether the laser center frequency is inboard or outboard of the filter center frequency. Thus, even though partial frequency doubling is detected, it may still be detected from the feedback signal in which direction and magnitude the laser signal should be driven for alignment.

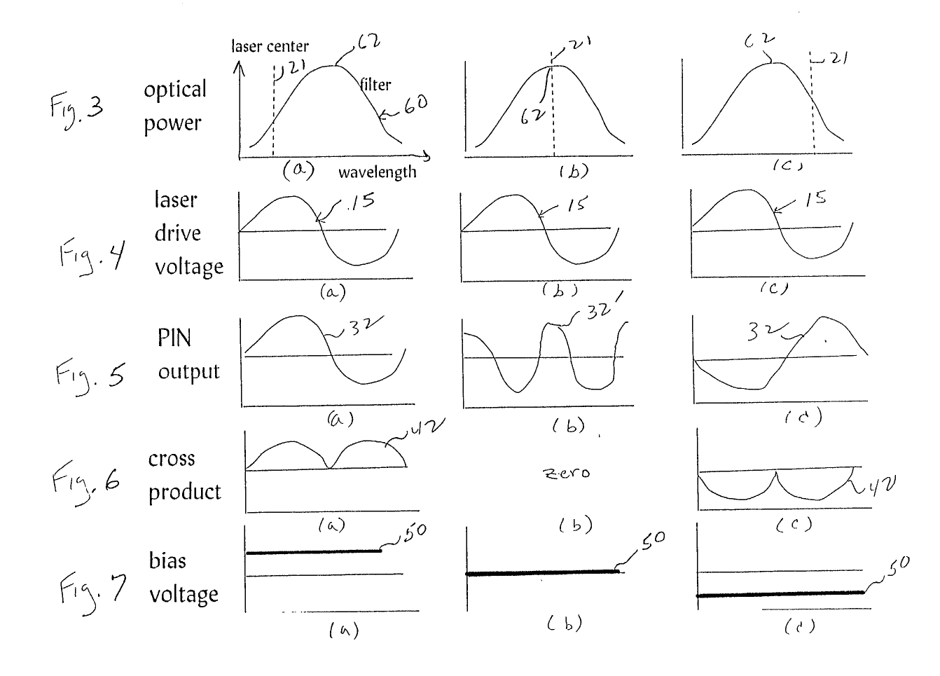

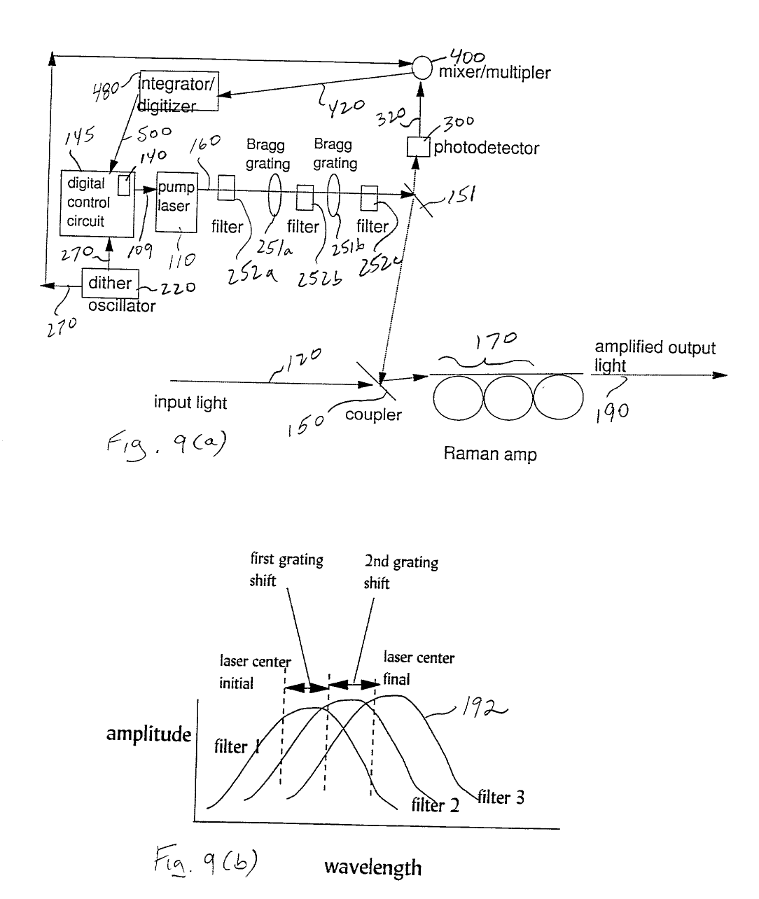

Referring now to FIGS. 6(a) and 6(c), for the case when the laser and filter are not aligned, the cross product signal 42 resulting from the mixing of the amplified feedback error with the original dither sinusoid is a signed error signal either at a first polarity (for the laser signals at frequencies below the bandpass filter centerpoint), such as shown in FIG. 6(a) or, at a second polarity (for the laser signals at frequencies above the bandpass filter centerpoint), such as shown in FIG. 6(c). Each of these signals may be rectified and converted into a digital output laser bias voltage signal 48 as shown in respective FIGS. 7(a) and 7(c), which are fed back to respectively increase or decrease the laser current (wavelength) in such a way that the laser center wavelength moves closer to the bandpass filter centerpoint. For the case when the laser and filter are aligned, the cross product generated is the frequency doubled signal (twice the frequency of the dither) as shown in the figures. Consequently, this results in a 0 V dc bias voltage (FIG. 7(b)) which will maintain the laser frequency centerpoint at its current wavelength value.

The process for automatically achieving increased gain for Raman effect optical amplifiers 100 according to a first embodiment of the present invention is now described with respect to FIG. 8. In this case, it is assumed that the wavelength of the input signal to be amplified is precisely controlled at the source (possibly using another wavelength locking method) so the critical parameter is control of the wavelength spacing between this source wavelength (input signal) and the pump signal wavelength. For simplicity, it is assumed that the filter used in the Raman amplifier is identical to the filter used at the source such as may be the case when both filters are fabricated on a common substrate at the same time (not shown). A wavelength locked loop is then implemented to tune the offset between the pump signal wavelength and the pump filter to 13.2 THz (0.2 nm). To accomplish such precise tuning and maintain it over the lifetime of the device, in spite of temperature, voltage, and ageing variations, an active feedback loop is required to tune the pump laser. Thus, it should be understood that this enables the use of a pump laser whose center wavelength is not as precisely controlled during its manufacturing process, and, consequently may be a lower cost pump source.

As shown in FIG. 8 there is depicted a pump system for a Raman effect amplifier 170 implementing the WLL principle. As shown in FIG. 8, a dither oscillator generator 220 provides a dither oscillation signal 270 that is input to a bias voltage control circuit 140 that enables dither modulation of the pump optical signal 160 output from the optical signal generator 110, e.g., a pump laser diode device. Thus, the nominal center wavelength of the pump laser signal 160 is dithered by a low frequency (kHz or less) dither oscillator source driving the semiconductor laser's bias voltage. The light 160 passing through the Raman pump filter element 250 is thus intensity modulated at a low frequency, which may be selected so as not to interfere with the operation of the pump or with other electrical frequencies in the data link. Most of this light, e.g., 99%, is used to pump the Raman amp 170; the rest of the optical signal, e.g., 1%, is tapped off using an optical splitter or coupler device 151 and diverted to a photodetector device 300, e.g., a P-I-N diode, which converts the tapped optical signal into an electrical feedback signal 320 that is proportional to the intensity modulation of the light. It is understood that the amount of light that may be tapped off may range anywhere between one percent (1%) to five percent (5%) of the optical output signal, however, skilled artisans will appreciate any amount of laser light above the noise level that retains the integrity of the output signal including the dither modulation characteristic, may be tapped off (i.e., less than 1%). This signal 320 feeds back to an electronic circuit including an amplifier (not shown) which amplifies the signal, and a mixer device 400, which mixes it with the original dither oscillator signal 270 to produce their vector cross product. The resulting signal 420 is then integrated and digitized by integrator device 480 which results in a control signal 500 that is zero value if the laser and filter center wavelengths are properly aligned (the cross product is frequency doubled, which averages out to zero when passing through the electronics). If, according to the WLL principles, the laser and filter are not aligned, the signal provides both the amount by which the laser must be adjusted to realign them and the direction (increase or decrease) in which the wavelength of the pump laser must be changed. A digital control circuit 145 is used to adjust the pump laser bias 109 by the appropriate amount to ensure that the center wavelength of the peaked function pump laser signal is precisely 13.2 THz away from the filter center wavelength. Since the amplifier input signal 120 is assumed to be locked to the filter center wavelength at its source, this provides a method of maintaining a desired offset between the pump 160 and input signal 120 wavelengths. It should be understood that the wavelength locked loop in the Raman amplifier 170 is not implemented to keep the pump laser and filter in exact alignment; but rather, is used to produce a controlled offset between the pump laser and filter center wavelengths so as to exploit the generation of the Stokes wave (i.e., at the Raman wavelength shift)). Additionally, it should be understood that this offset is accomplished by digital logic control circuitry 145 and is programmable, so that the amplifier may be used with different signal sources as desired.

In an alternate embodiment, depicted in FIG. 9(a), a pump laser signal 200 is not available near the desired signal wavelength. For example, this may occur when a source laser is near 1300 nm. In this case, multiple wavelength conversions are required for the pump which is enabled by a series connection of Bragg grating elements, e.g., elements 251a, 251b and filter elements, e.g., elements 252a, 252b and 252c, in an alternating fashion, which are used to tune the pump wavelength after each wavelength step. When an optical signal passes through multiple optical filters 252a-252c, it experiences a narrowing of the passband; several such changes make it difficult to precisely control the pump center wavelength. However, the WLL principle for precisely controlling the peaked passband function of a multi-stage filter as described in above-referenced, co-pending U.S. patent application Ser. No. 09/865,256, may be exploited for use with a multiple filter stage Raman amplifier pump, as shown in FIG. 9(a). That is, as shown in FIG. 9(a), all intermediate filter stages are incorporated into the wavelength-locked loop, which acts as a state machine to regulate the final output center wavelength of the shifted pump laser, preferably to the amount necessary to facilitate the Raman effect in the amplifier. FIG. 9(b) illustrates one example of a composite filter response 192 when the multi stage filter Raman amplifier device of FIG. 9(a) is implemented. Note that because multiple wavelength shifting stages are required in the Raman amplifier 170, precise wavelength control cannot be accomplished in any other way except by using the active feedback loops according to the WLL principle.

FIG. 10 is a detailed block diagram illustrating conceptually the operation of the digital control circuit 145 of FIGS. 8 and 9(a). As shown in FIG. 10, the digital control circuit 145 includes a comparison device 147 for comparing the actual measured wavelength of the pump, as represented by the feedback error signal 500, against the desired pump wavelength value advantageous for inducing the Raman effect in amplifier 170. That is, the comparison device 147 may be pre-programmed with the desired center wavelength based on the known filter characteristics. By comparing the actual pump laser signal wavelength, as represented by the error signal 500 which informs the logic circuit 145 of the magnitude and direction of the wavelength offset between the pump laser and its optical filter, against the programmed desired wavelength of the pump laser, an appropriate bias adjustment signal 108 may be generated which may be used by the bias voltage control circuit 140 to ensure that the pump laser signal is generated at the desired center wavelength, e.g., 13.2 THz away from the filter center wavelength. The adjusted dc bias signal 109 output from the generator 140 (which includes the ac dither modulation 270) is then input to the pump laser diode.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims. For instance, the WLL may be used to adjust the center wavelength of the peaked passband response of tunable Raman filter devices when implemented in each of the embodiments described.

Having thus described our invention, what we claim as new, and desire to secure by Letters Patent is:

1. A Raman effect amplifier for amplifying optical signals comprising:
an optical isolator device for receiving an input optical signal having an input frequency characteristic;
a laser pump device for generating a laser pump signal having a peaked spectrum function including a center wavelength;
a Raman filter element having a peaked passband function including a center wavelength implemented for receiving said laser pump signal and passing said laser pump signal at a predetermined wavelength advantageous for amplifying said input signal according to a Raman effect;
an optical fiber element for receiving said input optical signal and said laser pump signal and amplifying said input optical signal according to said Raman effect in response to receipt of a laser pump signal at said pre-determined wavelength; and,
a wavelength-locked loop servo-control circuit for enabling real time mutual alignment of said laser pump signal center wavelength with said Raman filter having said peaked passband function at said pre-determined wavelength, wherein said laser pump signal is maximally transferred to said optical fiber element at said pre-determined wavelength thereby resulting in increased gain response of said Raman effect amplifier at said input frequency.

2. The Raman effect amplifier as claimed in claim 1, wherein said wavelength-locked loop servo-control circuit comprises:
mechanism for applying a dither modulation signal at a dither modulation frequency to said laser pump signal, and inputting said dither modulated laser pump signal to said optical filter;
mechanism for converting a portion of said dither modulated laser pump signal to an electric feedback signal;
mechanism for continuously comparing said feedback signal with said dither modulation signal and generating an error signal representing a difference between a frequency characteristic of said feedback signal and a dither modulation frequency; and
mechanism for automatically adjusting a peaked spectrum function of said laser pump signal according to said error signal, wherein said center wavelength of said laser pump signal and said peaked passband function of said Raman filter become aligned when said frequency characteristic of said feedback signal is two times said dither modulation frequency.

3. The Raman effect amplifier as claimed in claim 1, wherein said laser pump device includes:
a pump laser diode device for generating said laser pump signal; and,
a laser bias voltage control circuit for providing a bias voltage to said pump laser diode device for controlling said laser signal, wherein said mechanism for automatically adjusting said optical signal includes applying said error signal to said pump laser bias control circuit for adjusting a center wavelength characteristic of said laser pump signal according to said predetermined wavelength.

4. The Raman effect amplifier as claimed in claim 1, wherein said device for applying a dither modulation to said bias signal is a sinusoidal dither circuit for generating a sinusoidal dither modulation signal of a predetermined frequency.

5. The Raman effect amplifier as claimed in claim 1, wherein said converting mechanism is a photodetector device.

6. The Raman effect amplifier as claimed in claim 5, wherein said photodetector device is a p-i-n diode.

7. The Raman effect amplifier as claimed in claim 4, wherein said device for comparing includes a mixer capable of combining said converted feedback signal with said sinusoidal dither modulation signal and generating a cross-product signal having components representing a sum and difference at dither frequencies.

8. The Raman effect amplifier as claimed in claim 7, further including:
low-pass filter device for filtering said output cross-product signal; and
integrator circuit for averaging said output cross-product signal to generate said error signal, whereby said error signal is positive or negative depending on whether a center wavelength of said laser pump signal is respectively less than or greater than said desired wavelength of said Raman filter.

9. The Raman effect amplifier as claimed in claim 2, wherein said peaked spectrum function of said laser pump signal is adjusted to a pre-determined center wavelength corresponding to about 13.2 THz above said input frequency.

10. The Raman effect amplifier as claimed in claim 1, wherein said Raman filter is a composite filter comprising a series connection of two or more Raman filter elements for enabling passing of a laser pump signal at a pre-determined frequency advantageous for amplifying said input signal according to a Raman effect.

11. The Raman effect amplifier as claimed in claim 10, wherein said composite filter includes one or more Bragg grating elements enabling said conversion of a center wavelength of said laser pump signal to said pre-determined frequency advantageous for amplifying said input signal according to a Raman effect.

12. A Raman effect amplifier for amplifying optical signals comprising:
an optical isolator device for receiving an input optical signal having an input frequency characteristic;
a laser pump device for generating a laser pump signal having a peaked spectrum function including a center wavelength;
a series connection of two or more Raman filter elements for providing a composite peaked passband function including a center wavelength implemented for receiving and passing a laser pump signal at a pre-determined wavelength advantageous for amplifying said input signal according to a Raman effect;
one or more Bragg grating elements enabling a conversion of a center wavelength of said laser pump signal to said pre-determined wavelength;
an optical fiber element for receiving said input optical signal and said laser pump signal and amplifying said input optical signal according to said Raman effect in response to receipt of a laser pump signal at said pre-determined wavelength; and,
a wavelength-locked loop servo-control circuit for enabling real time mutual alignment of said laser pump signal center wavelength with said composite peaked passband function at said pre-determined wavelength, wherein said laser pump signal is maximally transferred to said optical fiber element at said pre-determined wavelength thereby resulting in increased gain response of said Raman effect amplifier at said input signal frequency.

13. The Raman effect amplifier as claimed in claim 12, wherein said wavelength-locked loop servo-control circuit comprises:
mechanism for applying a dither modulation signal at a dither modulation frequency to said laser pump signal, and inputting said dither modulated laser pump signal to said series connection of two or more Raman filter elements;
mechanism for converting a portion of said dither modulated laser pump signal to an electric feedback signal;
mechanism for continuously comparing said feedback signal with said dither modulation signal and generating an error signal representing a difference between a frequency characteristic of said feedback signal and a dither modulation frequency; and
mechanism for automatically adjusting a peaked spectrum function of said laser pump signal according to said error signal, wherein said center wavelength of said laser pump signal and said composite peaked passband function of said two or more Raman filters
become aligned when said frequency characteristic of said feedback signal is two times said dither modulation frequency.

14. The Raman effect amplifier as claimed in claim 12, wherein said laser pump device includes:
a pump laser diode device for generating said laser pump signal; and,
a laser bias voltage control circuit for providing a bias voltage to said pump laser diode device for controlling said laser signal, wherein said mechanism for automatically adjusting said optical signal includes applying said error signal to said pump laser bias control circuit for adjusting a center wavelength characteristic of said laser pump signal.

15. The Raman effect amplifier as claimed in claim 12, wherein said device for applying a dither modulation to said bias signal is a sinusoidal dither circuit for generating a sinusoidal dither modulation signal of a predetermined frequency.

16. The Raman effect amplifier as claimed in claim 12, wherein said converting mechanism is a photodetector device.

17. The Raman effect amplifier as claimed in claim 16, wherein said photodetector device is a p-i-n diode.

18. The Raman effect amplifier as claimed in claim 15, wherein said device for comparing includes a mixer capable of combining said converted feedback signal with said sinusoidal dither modulation signal and generating a cross-product signal having components representing a sum and difference at dither frequencies.

19. The Raman effect amplifier as claimed in claim 18, further including:
low-pass filter device for filtering said output cross-product signal; and
integrator circuit for averaging said output cross-product signal to generate said error signal, whereby said error signal is positive or negative depending on whether a center wavelength of said laser pump signal is respectively less than or greater than said center wavelength of said composite peaked passband function.

20. The Raman effect amplifier as claimed in claim 13, wherein said Bragg grating elements enable conversion of said laser pump signal to a pre-determined center wavelength of about 13.2 THz above said input signal frequency.

21. The Raman effect amplifier as claimed in claim 13, wherein a Bragg grating filter element is connected between two Raman filter elements in an alternating fashion.

22. A method for amplifying optical signals in a Raman optical amplifier comprising the steps of:
a) receiving an input optical signal having an input frequency characteristic;
b) generating a laser pump signal having a peaked spectrum function including a center wavelength;
c) providing a Raman filter element having a peaked passband function including a center wavelength implemented for receiving said laser pump signal and passing said laser pump signal at a predetermined wavelength advantageous for amplifying said input signal according to a Raman effect;
d) implementing an optical fiber element for receiving said input optical signal and said laser pump signal and amplifying said input optical signal according to said Raman effect in response to receipt of a laser pump signal at said pre-determined wavelength; and,
e) providing a wavelength-locked loop servo-control circuit for enabling real time mutual alignment of said laser pump signal center wavelength with said Raman filter having said peaked passband function at said predetermined wavelength, wherein said laser pump signal is maximally transferred to said optical fiber element at said pre-determined wavelength thereby resulting in increased gain response of said Raman effect amplifier at said input frequency.

23. The method as claimed in claim 22, wherein said step d) of providing real-time alignment further comprises the steps of:
applying a dither modulation signal at a dither modulation frequency to said laser pump signal, and inputting said dither modulated laser pump signal to said optical filter;
converting a portion of said dither modulated laser pump signal to an electric feedback signal;
continuously comparing said feedback signal with said dither modulation signal and generating an error signal representing a difference between a frequency characteristic of said feedback signal and a dither modulation frequency; and
automatically adjusting a peaked spectrum function of said laser pump signal according to said error signal, wherein said center wavelength of said laser pump signal and said peaked passband function of said Raman filter becoming aligned when said frequency characteristic of said feedback signal is two times said dither modulation frequency.

24. The method as claimed in claim 23, wherein said Raman effect amplifier includes a pump laser diode device for generating said laser pump signal; and, a laser bias voltage control circuit for providing a bias voltage to said pump laser diode device for controlling said laser signal, said step of automatically adjusting further including: applying said error signal to said pump laser bias control circuit for adjusting a center wavelength characteristic of said laser pump signal.

25. The method as claimed in claim 24, wherein said continuously comparing step includes the steps of:
combining said converted feedback signal with said dither modulation signal and generating a cross-product signal having components representing a sum and difference at dither frequencies.
filtering said output cross-product signal; and
averaging said output cross-product signal to generate said error signal, said error signal being positive or negative depending on whether a center wavelength of said laser pump signal is respectively less than or greater than said pre-determined wavelength of said Raman filter.

26. The method as claimed in claim 23, wherein said step c) of providing a Raman filter element includes the step of:
providing a series connection of two or more Raman filter elements for providing a composite peaked passband function including a center wavelength implemented for passing of a laser pump signal at a pre-determined frequency advantageous for amplifying said input signal according to a Raman effect; and,
providing one or more Bragg grating elements for enabling conversion of a center wavelength of said laser pump signal to said predetermined frequency.
